(19) United States
(12) Patent Application Publication
(10) Pub. No.: US 2002/0140824 A1
(43) Pub. Date: Oct. 3, 2002

(54) System and method for processing low illumination image data

(76) Inventors: Jordan C. Christoff, Santa Barbara, CA (US); David Paul Holmes, Goleta, CA (US)

Correspondence Address: Alan M. Weisberg, Christopher & Weisberg, P.A., Suite 2040, 200 East Las Olas Boulevard, Fort Lauderdale, FL, 33301, US

(21) Appl. No.: 10/112,555

(22) Filed: Mar. 29, 2002

Related U.S. Application Data
(60) Provisional application No. 60/280,875, filed on Apr. 2, 2001.

(51) Int. Cl. H04N 9/04

(52) U.S. Cl. 348/216.1

(57) ABSTRACT

A video camera and method therefore for use in a low light environment. A video image capturing element captures an image in the low light environment and generates a low light image signal corresponding to the captured image. A video processing unit is electrically coupled to the video image capturing element. The video processing unit has a memory for storing a raw digitized version of the low light image signal and a signal processing device electrically coupled to the memory. The signal processing device reads the raw digitized version of the low light image signal from the memory at a rate corresponding to a full rate signal and converts the raw digitized version of the low light image signal into a displayable video signal. The camera and method of the invention are well suited for use in a closed circuit television surveillance environment.

### CROSS-REFERENCE TO RELATED APPLICATION

This application is related to and claims priority to U.S. Provisional Application Serial No. 60/280,875, filed Apr. 02, 2001, entitled VIDEO SYSTEM AND METHOD, the entirety of which is incorporated herein by reference.

### STATEMENT REGARDING FEDERALLY SPONSORED RESEARCH OR DEVELOPMENT

n/a

### FIELD OF THE INVENTION

The present invention relates to a method for video image capture, and in particular, to a method and system for capturing low illumination video data for display on a video monitor.

### BACKGROUND OF THE INVENTION

Video systems are implemented in myriad lighting conditions, including low light conditions. The cameras included with these systems must be able to capture image data in the low light conditions in order to present a viewable image on a display monitor without flashing or missing frames or video fields. In order to allow a video imaging device to produce an acceptable video signal under low illumination conditions, the imaging device must collect light over a longer period of time than under normal illumination conditions. The light collection over a long period of time is referred to as long integration. Long or slow integration refers to the accumulation of light on a charged coupled device (“CCD”) lens for a period of time which is longer than the field or frame scan rate. For example, in a National Television Standards Committee (“NTSC”) system, long integration refers to the accumulation of light on the CCD for longer than 1/60^{th} of a second. Of note, if the image is too dark, the long integration results in the skipping of fields or frames until the accumulation is enough to generate a field or frame. This appears as a “flash” on the display screen.

For a video imaging device to produce a continuous sequence of output images at a higher rate than the input image update rate, a memory is required. This memory must hold the acquired input image until a new image is acquired, thereby allowing the output to produce images at a rate compatible with downstream devices. In a typical video acquisition system, the memory device is positioned in the circuit downstream of the video digital signal processor (“DSP”). A typical video imaging device includes a CCD coupled to a correlated double sampler (“CDS”)/automatic gain control (“AGC”) device which is in turn coupled to an analog-to-digital (“A/D”) converter. Typically, the A/D converter is coupled to a DSP which takes the mosaic color pattern and digitized CCD data and makes an RGB signal which includes luminance and chrominance data. In other words, the DSP takes in a single bit stream and provides a bit stream which is typically double in size of the input bit stream. For example, an 8 bit input to the DSP results in an 8 bit chrominance output signal and an 8 bit luminance output signal. The luminance signal and chrominance signal are then provided to the memory device. As such, the memory device must be arranged to store two times the amount of data originally developed by the A/D converter coupled to the CDS/AGC device. This arrangement is inefficient and wastes expensive memory.

Also, as noted above, prior art devices not only require memory to store chrominance and luminance data, but also must be adapted to hold the acquired input image until new data is acquired. However, because the memory is downstream of the DSP, the memory output which is fed to a digital-to-analog (“D/A”) converter to provide the analog video signal output of the imaging device may not have valid imaging data in the case where long integration is required due to low illumination levels. The result is that the D/A converter receives invalid data corresponding to a black frame until such time as the accumulated image data stored in the memory is at a level which is sufficient to provide a valid field or frame. The periodic supply of valid image data is seen as the above-described “flash” on the display monitor. Of note, however, the above-described prior art component arrangement is conducive to a video camera which can operate under normal lighting conditions.

It is therefore desired to have a system in which the imaging data provided to the video memory is stored prior digital signal processing and separation into luminance data and chrominance data. In other words, it is desired to have an arrangement which stores the smaller-sized unseparated raw image data. It is further desired to have a video imaging system which operates equally well in a low illumination environment and a normal illumination environment such that the resultant analog video signal provided to a display monitor in which the video signal corresponds to a low illumination, long integration, signal is easily viewable and is devoid of black frames, flashes, and the like.

### SUMMARY OF THE INVENTION

In accordance with an aspect, the present invention advantageously provides a video camera for use in a low light environment, in which a video image capturing element captures an image in the low light environment. The video image capturing element generates a low light image signal corresponding to the captured image. A video processing unit is electrically coupled to the video image capturing element. The video processing unit has a memory for storing a raw digitized version of the low light image signal and a signal processing device electrically coupled to the memory in which the signal processing device reads the raw digitized version of the low light image signal from the memory at a rate corresponding to a full rate signal and converts the raw digitized version of the low light image signal into a displayable video signal.

In accordance with another aspect, the present invention provides a video system operable in a low light environment, in which the video system has a user actuated keyboard controller operable to generate a control signal in response a user actuation, a video display, a camera and a video switch operatively coupling the keyboard controller, the video display and the camera to transmit the control signal to the camera and to transmit the video signal from the camera to the video display.

The camera generates a video signal is operable in response to the control signal. The camera has a video image capturing element for capturing an image in the low light environment in which the video image capturing element generates a low light image signal corresponding to the captured image and a video processing unit. The video processing unit is electrically coupled to the video image capturing element and has a memory for storing a raw digitized version of the low light image signal and a signal processing device electrically coupled to the memory. The signal processing device reads the raw digitized version of the low light image signal from the memory at a rate corresponding to a full rate signal and converts the raw digitized version of the low light image signal into a displayable video signal.

In accordance with still another aspect, the present invention provides A method for processing a displayable video image in a low light environment in which an image is captured in the low light environment. A low light image signal is generated corresponding to the captured image. A raw digitized version of the low light image signal is stored. The raw digitized version of the stored low light image signal is read at a rate corresponding to a full rate signal. The raw digitized version of the low light image signal is converted into a displayable video signal.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of a video system constructed in accordance with the principles of the present invention;

FIG. 2 is a block diagram of a camera constructed in accordance with the principles of the present invention;

FIG. 3 is a block diagram of a video processing unit constructed in accordance with the principles of the present invention; and

FIG. 4 is a flow chart of the operation of a camera constructed in accordance with the principles of the present invention in a low illumination environment.

### DETAILED DESCRIPTION OF THE INVENTION

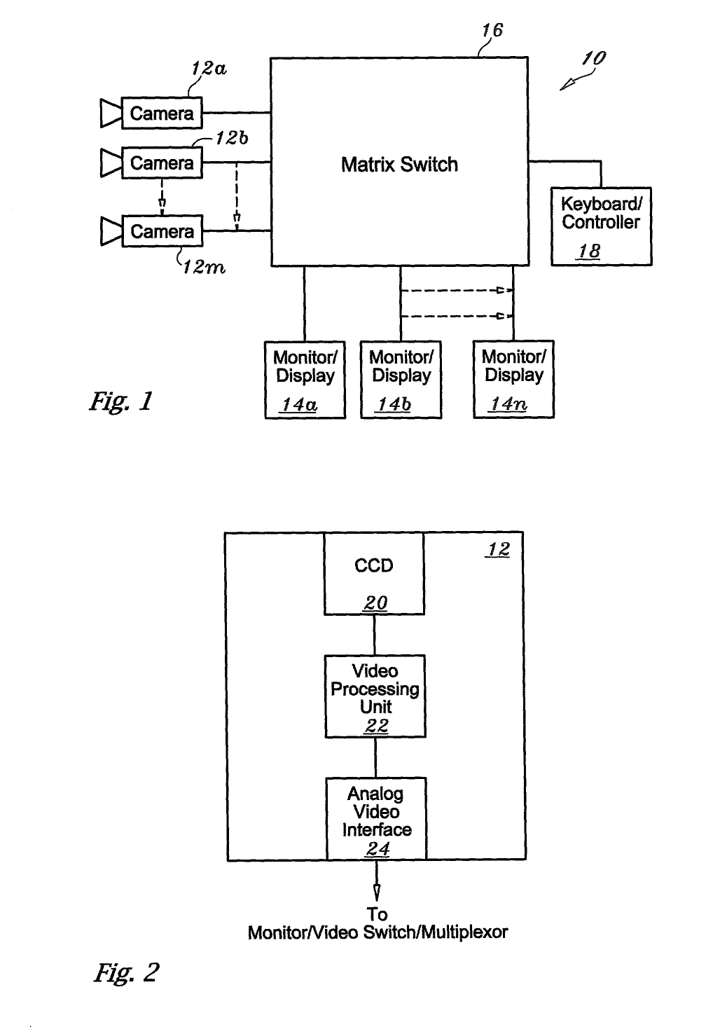

Referring now to the drawing figures, in which like reference designators refer to like elements, there is shown in FIG. 1 a block diagram of a video system, such as a video surveillance closed circuit television (CCTV) system, for use in monitoring multiple scenes from multiple locations, constructed in accordance with the principles of the present invention and designated generally as 10. System 10 includes up to “m” video cameras 12a, 12b, through 12m, along with up to “n” video monitors or displays 14a, 14b, through 14n, (where “m” and “n” are whole numbers) coupled to a video switch 16 having at least one keyboard controller 18 connected thereto. Cameras 12a through 12m are collectively referred to herein as cameras 12 and video monitors 14a-14n are collectively referred to herein as video monitors 14.

The cameras 12 maybe any of a variety of video or still cameras, acquiring a picture using a lens, iris, zoom and focus controls, integrated optics package, or other image acquisition device which include the low image illumination capture features described below. The cameras 12 may be included inside of a housing such a semi-hemispherical dome, suitable for affixation onto a surface. The housing may also include a set of orientational controls, such as pan and tilt motors and actuators for moving and orienting the direction of the image acquisition device. An example of such a camera 12 and housing is the SPECTRA series of video surveillance units manufactured by Pelco.

Each camera 12 is connected to video switch 16, such a multi-input and output “matrix” switch. Switch 16 contains a variety of components, including a computer and control circuit electronics for controlling the operation of each camera 12, through commands and codes received by the keyboard controller 18. Both cameras 12 and keyboard controller 18 may be disposed at remote locations from switch 16. Switch 16 is further connected to a number “n” of monitor displays 14. The “matrix” therefore, contains m X n channels for m camera inputs and n monitor outputs. One example of such a matrix switch is the CM 6800 switch manufactured by Pelco, which provides m =48 and n =8.

As used herein, the terms, “long integration”, “slow shutter operation” and “low light environment” and “slow integration” are used interchangeably and refer to a light level which is so low that it requires accumulation of light on a charged coupled device (“CCD”) for longer than one video field; 1/60^{th} of a second for NTSC and 1/50^{th} of a second for Phase Alternating Line (“PAL”). In a low illumination condition, because the image capturing element such as the CCD must be allowed to accumulate light for longer than the video frame time, the video scan has already began its next frame scan by the time a light level significant enough to provide an intelligible, displayable video image has been accumulated.

FIG. 2 is a block diagram of a camera 12 arranged in accordance with the principles of the present invention to efficiently process an image captured in a low light, i.e. long integration, environment. Camera 12 constructed in accordance with the principles of the present invention preferably includes a video image capturing element such as a CCD, a video processing unit 22 electrically coupled to the CCD, and an analog video interface 24 electrically coupled to video processing unit 22. Analog video interface 24 is connectable to a monitor, video switch, multiplexor, etc. for further processing and/or display on monitor 14. Of note, although camera 12 is shown as including analog video interface 24, it is contemplated that the below-described analog interface electronics can be omitted and a digital video signal output provided instead for direct attachment to a suitably equipped digital video monitor, outboard digital-to-analog (“D/A”) converter and the like.

CCD 20 can be any video image capturing element suitable to accumulate an image and output the image signal for further video processing. It has been found that known CCDs arranged for interline transfer can be used.

Although discussed below in detail, video processing unit 22 includes components advantageously arranged to optimize camera 12 for long integration while allowing camera 12 to perform equally well in light conditions other than low light conditions. In other words, video processing unit 22 is arranged to produce a displayable video image even when the image is captured in a low light condition and provides a displayable video signal to analog video interface 24 such that the displayable video signal is devoid of “flashes”. Video processing unit 22 is therefore arranged to provide valid video data at its output whether that output is an analog displayable video signal provided to analog video interface 24 or is in the form of a digital video signal for transmission to a digital monitor or outboard D/A converter.

Analog video interface 24 includes the circuitry and physical connectors to provide a desired standardized video signal. For example, analog video interface 24 can be arranged as a composite video interface, S-video interface, or component video interface.

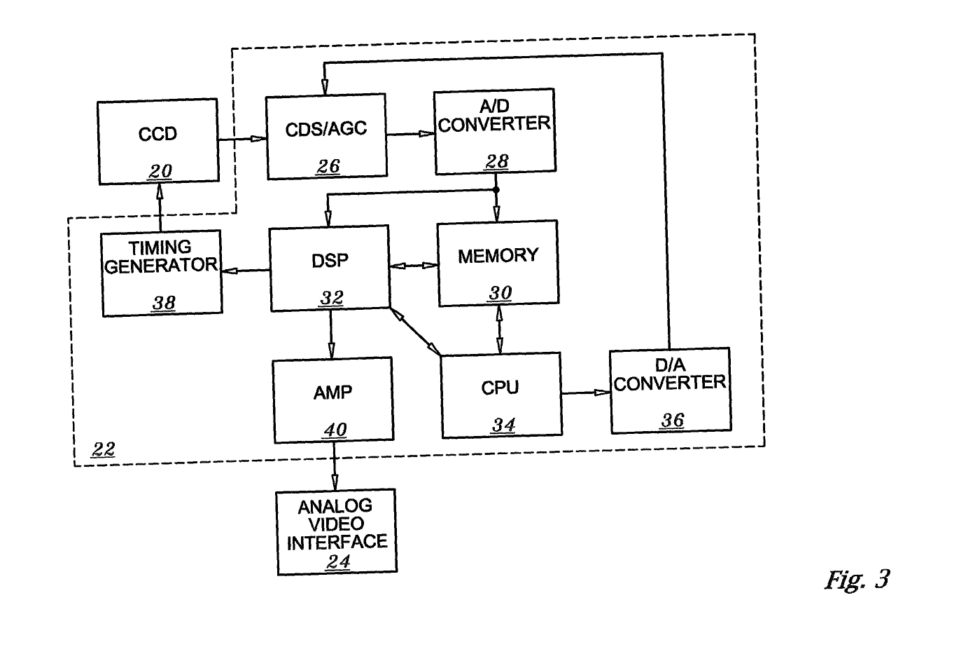

Video processing unit 22 is explained in detail with reference to the block diagram shown in FIG. 3. Video processing unit 22 includes correlated double sampler/automatic gain control (“CDS/AGC”) 26 coupled to analog-to-digital (“A/D”) converter 28 which is in turn coupled to memory 30 and digital signal processor (“DSP”) 32. Video processing unit 22 also includes central processing unit (“CPU”) 34 coupled to memory 30 and DSP 32 and is further coupled to digital-to-analog (“D/A”) converter 36. D/A converter 36 is used to convert a digital signal corresponding to a gain amount received from CPU 34 and provide the analog equivalent to CDS/AGC 26 to control the gain of CDS/AGC 26.

Video processing unit 22 further includes timing generator 38 which is arranged to receive a control output from DSC 32 to generate shutter speed timing for CCD 20. Although timing generator 38 is shown coupled to DSP 32 in FIG. 3, it is also contemplated that timing generator 38 can instead be controlled by CPU 34. Timing generator 38 is typically an application-specific integrated circuit (“ASIC”) having timing capabilities matched to CCD 20. Although any suitably matched timing generator 38 can be used as part of the present invention, timing generator 38 should be capable of long integration timing rates, i.e. capable of generating a timing signal at a rate slower than 1/60^{th} of a second for NTSC and 1/50^{th} of a second for PAL.

In a case where, as shown in FIGS. 2 and 3, an analog displayable video signal is to be provided as the video signal output, video processing unit 22 further includes video amplifier 40 coupled to the video signal output of DSP 32. Video signal amplifier 40 can be any video amplifier having a bandwidth large enough to amplify the video signal output of DSP 32 and provide that amplified output to the desired type of analog video interface 24. Of course, in a case where a digital video signal output is provided instead of an analog video output, video amplifier 40 can be omitted if DSP 32 can provide a digital signal level suitable for its intended use. Otherwise, a suitable digital video amplifier is implemented as video amplifier 40.

Referring again to FIG. 3, CDS/AGC 26 can be any device suited to accepting an analog image signal from CCD 20, provide analog gain based on gain level instructions received from CPU 34 via D/A converter 36 and provide an output to A/D converter 28.

A/D converter 28 is adapted to receive the output from CDS/AGC 26 and convert that output into pixelized raw digital image data. For example, an 8-bit A/D converter converts the gain and level adjusted image signal captured by CCD 20 into an 8-bit color pixelized digital representation of the gain and level adjusted image data. Also, it is noted that, although an 8-bit A/D converter 28 can be used, A/D converter 28 is preferably a 10-bit high speed A/D converter capable of 20 megasamples per second. In accordance with an embodiment of the present invention, A/D converter 28 is 10-bit A/D converter operated at 14.3 megaHertz.

As is shown in FIG. 3, the pixelized image data output by A/D converter 28 is input into both memory 30 and DSP 32. In accordance with this arrangement, memory 30 need only be capable of storing the raw digitized version of the image signal, i.e. the pixelized image data instead of having to store video image luminance data and video image chrominance data. Because luminescence data and chrominance data are each derived to separately be the same size as the raw pixelized image data, systems which implement memory 30 only as an output of DSP 32 must be arranged to store twice the amount of data as the present invention. In other words, if A/D converter 28 is arranged to provide an 8-bit output, memory 30 constructed in accordance with the present invention must be sized to store a single 8-bit representation of the video data whereas, in prior art systems, the luminance data and chrominance data would each be 8 bits, so the frame memory in prior art devices needs to be sized to accommodate a video frame represented by a 16-bit data.

Memory 30 can be any memory suited for storing raw digitized video images but is preferably a dual-ported first-in-first-out (“FIFO”) memory arranged for simultaneous reading and writing. As an alternative, memory 30 can be implemented as a static random access memory or dynamic random access memory controlled by a programmable logic device such as a field programmable gate array. However, implementing memory 30 as a FIFO memory saves space and lowers the cost of camera 12. In accordance with the present invention, memory 30 can be implemented as 3 megabit memory.

Further, although memory 30 is preferably a dual-ported FIFO memory, the present invention can be implemented as a single-port FIFO memory even when supporting a low illumination mode. When using dual-ported memory, DSP 32 can read from memory 30 while A/D converter 28 is writing into memory 30. This allows DSP 32 to continuously read memory 30 to determine whether memory 30 contains a valid, i.e. non-black frame. However, when using a single-port FIFO memory, DSP 32 can be programmed to obtain data from A/D converter 28 while A/D converter 28 is writing into memory 30 when a valid frame is present and DSP 32 can be programmed to read only from memory 30 when a black, i.e. invalid image data is detected as being output by A/D. converter 28.

In accordance with the present invention, DSP 32 is advantageously any video DSP which accepts mosaic color pattern and digitized CCD data and processes that data to derive a suitable digital or analog displayable video signal output, for example, an RGB or luminance/chrominance video signal. As such, DSP 32 can be a DSP typically suitable for use in a normal light environment. In other words, DSP 32 need not be physically altered to accommodate long integration.

CPU 34 is any microprocessor, microcontroller, and the like suitable for operation and control in a video imaging environment. For example, CPU 34 can be an 8-bit/flash microprocessor arranged to control and carry out the functions of the present invention described herein. In operation, CPU 34 obtains image brightness data from DSP 32 and, based on the image brightness data, decides whether to enter a low illumination mode, stay in a low illumination mode, or enter any other mode of operation suitable for long integration, slow shutter operation. As noted above, CPU 34 also provides a gain signal to CDS/AGC 26 via D/A converter 36. Although not shown, the memory device storing the programmatic code executed by CPU 34 can be included as part of CPU 34 or provided external to CPU 34 as part of video processing unit 22.

In accordance with the present invention, raw image data is provided by A/D converter 28 and stored in memory 30. Because memory 30 is also coupled to DSP 32, the raw imager data can be stored in memory 30 and presented to DSP 32 as if it were coming directly from A/D converter 28. This arrangement advantageously provides a de facto 2:1 compression of the data, i.e. requires half the memory of prior art systems, and DSP 32 need not be physically changed to accommodate long integration. In accordance with this arrangement, and as described below in detail, memory 30 can be read out by DSP 32 at its customary rate, i.e. the rate it operates at when in a normal light level mode, so that DSP 32 is not adversely affected in terms of the image it is processing. To DSP 32, it appears that a normal full rate, i.e. normal light level signal, is being input directly from A/D converter 28. When operating in such a normal light level mode, DSP 32 can obtain image data directly from A/D converter 28, but when operating in a low illumination mode, DSP 32 is instructed to obtain its raw image data from memory 30. This allows for long integration operation without processing invalid, i.e. black video image data.

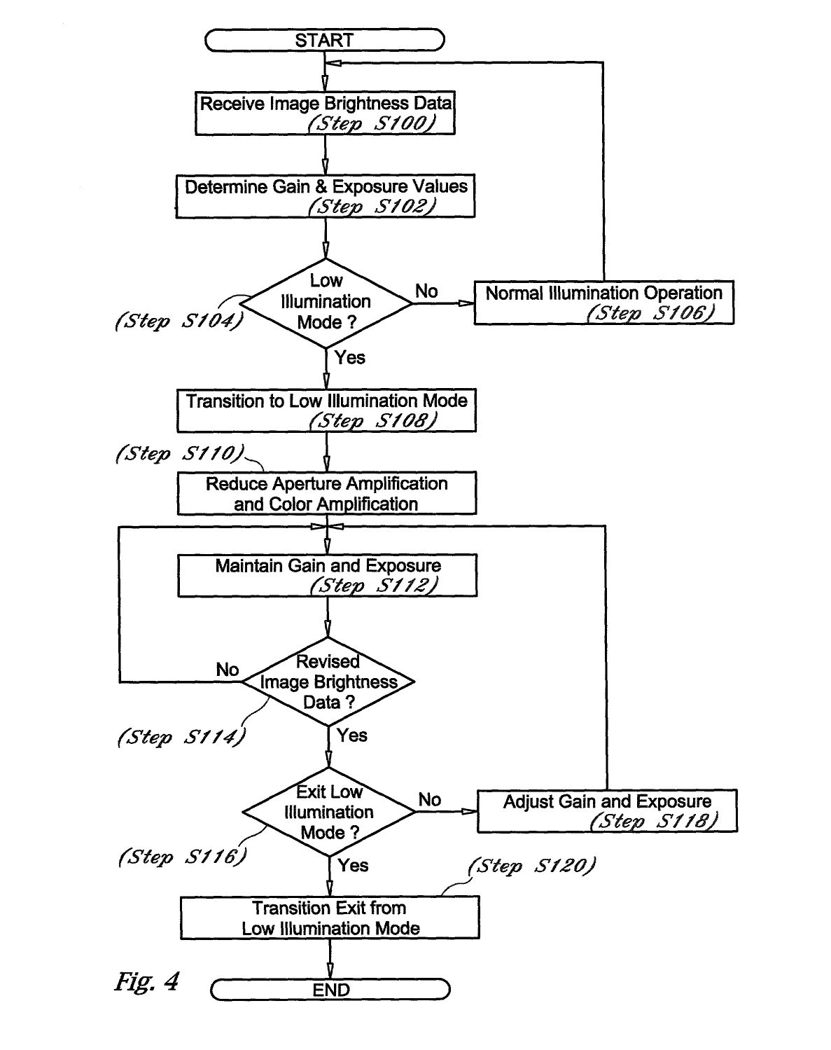

The operation of camera 12 in a low illumination environment is explained with reference to the flow chart in FIG. 4. Initially, CPU 34 receives image brightness data from DSP 32 as to the light levels in the image captured by CCD 20 (Step S100). The image data can be derived based on image data from multiple image zones. For example, the entire image can be divided into five zones in which an average brightness is reported for each zone. It is also contemplated that the minimum brightness and/or maximum brightness for the entire image or an image divided into multiple zones can be provided to CPU 34. It is further contemplated that histogram data about the number of pixels above and below threshold levels set by CPU 34 can be reported and determined.

CPU 34 determines the correct gain and exposure values based on the brightness data (Step S102). As noted above, gain is implemented via CDS/AGC 26. Preferably, the gain can be varied from about 8 dB to 40 dB. The exposure value can be varied from 8 seconds to 1/100,000 second. However, it has been found that the present invention performs most optimally when the maximum exposure time is capped at ½ second.

If the image brightness data is equal to or more than a predetermined amount, normal illumination operation is maintained (Step 106) and the process reverts to Step S100. If the image brightness data corresponds to an image brightness of less than the predetermined amount, a low illumination mode will be entered. Image brightness data for a low illumination mode implies that the exposure value must be set a value longer than the field scan rate, 1/60^{th} of a second for NTSC and 1/50^{th} of a second for PAL. For example, an exposure value for long integration, i.e. low illumination mode, is 1/30^{th} of a second.

If low illumination mode is to be entered (Step S104), CPU 34 arbitrates the transition from normal exposure to long exposure low illumination mode (Step S108). When transitioning, CPU 34 uses the gain to compensate for the large jump in exposure value from 1/60^{th} of a second to 1/30^{th} of a second. Without this compensation, the user would perceive a big jump in the brightness on the screen at the transition. As low illumination mode is entered, CPU 34 modifies appropriate parameters to reduce apparent noise as would be understood of ordinary skill in the art (step not shown). Further, CPU 34 can be optionally programmed to reduce aperture amplification and color amplification (Step S110). At this point, camera 12 is operating in a low illumination mode. When operating in low illumination mode, CPU 34 is programmed to only gather image brightness data at the rate of new valid field acquisition. As such, gain and exposure values are maintained (Step S112) until revised image brightness data is made available to CPU 34 (Step S114). This arrangement advantageously prevents oscillation and perturbations in the resultant output displayable video signal.

Where revised image brightness data is obtained, the image brightness data is evaluated and a determination made as to whether low illumination mode should be exited (Step S116). This determination is made on bases similar to those described above with respect to Step S104. If low illumination mode is to be maintained, gain and exposure values are adjusted as necessary (Step S118) and the process reverts to Step S112. If the revised image brightness data indicates that low illumination mode must be exited, CPU 34 controls the transition from low illumination mode (Step S120). For example, CPU 34 controls the transition from low illumination mode to normal illumination operation by using the gain to compensate for the 2 to 1 step change when changing from 1/30^{th} of a second to 1/60^{th} of a second exposure. Other camera parameters are returned to normal values and the gain and exposure values for normal operation are used once the transition is complete.

Of note, although only certain parameters are discussed above which are adjusted by CPU 34 based on image brightness data, it is understood by one of ordinary skill in the art that other parameters can be adjusted. As such, it is contemplated that the transition to and from low illumination mode and normal illumination operation can include adjustment of other video parameters.

In accordance with the above-described invention, the arrangement of memory 30 and DSP 32 with respect to A/D converter 28 combined with the above-described operational process performed by CPU 34 provides a displayable video signal which can be efficiently and effectively generated in low light conditions. Further, the present invention advantageously allows the use of a DSP which does not require physical modification from those known in the art. As such, the present invention advantageously provides an efficient, but low cost solution to implementing a camera which can operate to provide a high quality displayable video signal in low light conditions.

The present invention is advantageously arranged to provide valid image data to DSP 32 even in low illumination conditions. Further, the valid image data is stored in a memory which need only be approximately half the size of memory devices used in known cameras.

In accordance with the present invention, a camera equipped with the above-described video processing unit is well suited for use in video surveillance closed circuit television systems in which cameras are routinely placed in locations in which the lighting conditions are poor. Further, by minimizing the quantity of parts needed to implement the present invention, camera size can be minimized, making the cameras well suited for installations where stealthiness is desired.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A video camera for use in a low light environment, comprising:
a video image capturing element for capturing an image in the low light environment, the video image capturing element generating a low light image signal corresponding to the captured image; and
a video processing unit electrically coupled to the video image capturing element, the video processing unit having:
a memory for storing a raw digitized version of the low light image signal; and
a signal processing device electrically coupled to the memory, the signal processing device reading the raw digitized version of the low light image signal from the memory at a rate corresponding to a full rate signal and converting the raw digitized version of the low light image signal into a displayable video signal.

2. The video camera according to claim 1, wherein the video image capturing element is a charge coupled device.

3. The video camera according to claim 1, wherein the memory is a dual ported first in first out memory.

4. The video camera according to claim 1, further including a field programmable gate array electrically coupled to the memory and being adapted to control data transfer to and from the memory.

5. The video camera according to claim 1, wherein a capacity of the memory is less than approximately three megabits.

6. The video camera according to claim 1, wherein the video processing unit further includes a central processor in electrical communication with the memory and the signal processor, the central processor receiving image brightness data from the signal processor.

7. The video camera according to claim 6, wherein the image brightness data is comprised of average image brightness data from a plurality image zones.

8. The video camera according to claim 6, wherein the image brightness data corresponds to a low illumination mode if the image brightness data corresponds to an image brightness of less than a predetermined amount.

9. The video camera according to claim 8, wherein the central processor further operates to reduce aperture amplification and color amplification prior to entering the low illumination mode.

10. The video camera according to claim 8, wherein the central processor transitionally adjusts a camera exposure and a gain to enter the low illumination mode.

11. The video camera according to claim 10, wherein the central processor maintains a same camera exposure and gain when operating in the low illumination mode in the absence of revised image brightness data.

12. The video camera according to claim 8, wherein the central processor transitionally adjusts a camera exposure and a gain to exit the low illumination mode.

13. The video camera according to claim 1, wherein the video processing unit further includes:
a correlated double sampling unit in electrical communication with the video image capturing element; and
a central processor in electrical communication with the memory, the signal processor and the correlated double sampling unit, the central processor:
receiving image brightness data;
establishing a low illumination mode when the image brightness data corresponds to an image brightness of less than a predetermined amount; and
controlling the correlated double sampling unit, memory and signal processor to operate in the low illumination mode.

14. The video camera according to claim 13, wherein the image brightness data is received from the signal processor.

15. The video camera according to claim 14, wherein the image brightness data is comprised of average image brightness data from a plurality image zones.

16. The video camera according to claim 1, wherein the video image capturing element and video processing unit are included as part of a video surveillance system.

17. The video camera according to claim 1, wherein the displayable video signal is an analog video signal.

18. A video system operable in a low light environment, the video system comprising:
a user actuated keyboard controller, the keyboard controller being operable to generate a control signal in response a user actuation;
a video display;
a camera generating a video signal and being operable in response to the control signal, the camera comprising:
a video image capturing element for capturing an image in the low light environment, the video image capturing element generating a low light image signal corresponding to the captured image; and
a video processing unit electrically coupled to the video image capturing element, the video processing unit having:
a memory for storing a raw digitized version of the low light image signal; and
a signal processing device electrically coupled to the memory, the signal processing device reading the raw digitized version of the low light image signal from the memory at a rate corresponding to a fall rate signal and converting the raw digitized version of the low light image signal into a displayable video signal; and
a video switch, the switch operatively coupling the keyboard controller, the video display and the camera to transmit the control signal to the camera and to transmit the video signal from the camera to the video display.

19. The video system according to claim 18, wherein the video image capturing element is a charge coupled device.

20. The video system according to claim 19, wherein the memory is a dual ported first in first out memory.

21. The video system according to claim 19, further including a field programmable gate array electrically coupled to the memory and being adapted to control data transfer to and from the memory.

22. The video system according to claim 20, wherein a capacity of the memory is less than approximately three megabits.

23. The video system according to claim 18, wherein the video processing unit further includes a central processor in electrical communication with the memory and the signal processor, the central processor receiving image brightness data from the signal processor.

24. The video system according to claim 23, wherein the image brightness data is comprised of average image brightness data from a plurality image zones.

25. The video system according to claim 23, wherein the image brightness data corresponds to a low illumination mode if the image brightness data corresponds to an image brightness of less than a predetermined amount.

26. The video system according to claim 25, wherein the central processor further operates to reduce aperture amplification and color amplification prior to entering the low illumination mode.

27. The video system according to claim 25, wherein the central processor transitionally adjusts a camera exposure and a gain to enter the low illumination mode.

28. The video system according to claim 27, wherein the central processor maintains a same camera exposure and gain when operating in the low illumination mode in the absence of revised image brightness data.

29. The video system according to claim 25, wherein the central processor transitionally adjusts a camera exposure and a gain to exit the low illumination mode.

30. The video system according to claim 18, wherein the video processing unit further includes:
a correlated double sampling unit in electrical communication with the video image capturing element; and
a central processor in electrical communication with the memory, the signal processor and the correlated double sampling unit, the central processor:
receiving image brightness data;
establishing a low illumination mode when the image brightness data corresponds to an image brightness of less than a predetermined amount; and
controlling the correlated double sampling unit, memory and signal processor to operate in the low illumination mode.

31. The video system according to claim 30, wherein the image brightness data is received from the signal processor.

32. The video system according to claim 31, wherein the image brightness data is comprised of average image brightness data from a plurality image zones.

33. The video system according to claim 18, wherein the displayable video signal is an analog video signal.

34. A method for processing a displayable video image in a low light environment, the method comprising:
capturing an image in the low light environment;
generating a low light image signal corresponding to the captured image;
storing a raw digitized version of the low light image signal; and
reading the raw digitized version of the stored low light image signal at a rate
corresponding to a full rate signal; and
converting the raw digitized version of the low light image signal into a displayable video signal.

35. The method according to claim 34, further comprising receiving image brightness data.

36. The method according to claim 35, wherein the image brightness data is comprised of average image brightness data from a plurality image zones.

37. The method according to claim 35, further comprising entering a low illumination mode if the image brightness data corresponds to an image brightness of less than a predetermined amount.

38. The method according to claim 37, further comprising reducing aperture amplification and color amplification prior to entering the low illumination mode.

39. The method according to claim 37, wherein entering the low illumination mode includes transitionally adjusting a camera exposure and a gain.

40. The method according to claim 37, further including:
operating in the entered low illumination mode;
maintaining a same camera exposure and gain in the absence of revised image brightness data.

41. The method according to claim 40, further comprising transitionally adjusting the camera exposure and the gain to exit the low illumination mode.

42. The method according to claim 34, wherein the video processing unit further includes:
receiving image brightness data; and
establishing a low illumination mode when the image brightness data corresponds to an image brightness of less than a predetermined amount.

43. The method according to claim 34, wherein the displayable video signal is an analog video signal.
